(19) United States
(12) Patent Application Publication
(10) Pub. No.: US 2006/0157891 A1
(43) Pub. Date: Jul. 20, 2006

(54) Insert injection-compression molding of polymeric PTC electrical devices

(75) Inventors: Joseph T. Hardy, Worcester, MA (US); Erling Hansen, Redwood City, CA (US); Martin Matthiesen, Fremont, CA (US); Bruce J. Sparks, Fremont, CA (US); Anthony Vranicar, Santa Clara, CA (US)

Correspondence Address: TYCO ELECTRONICS CORPORATION, MAIL STOP R20/2B, 307 CONSTITUTION DRIVE, MENLO PARK, CA, 94025, US

(73) Assignee: Tyco Electronics Corporation, Middletown, PA (US)

(21) Appl. No.: 11/330,694

(22) Filed: Jan. 11, 2006

Related U.S. Application Data
(60) Provisional application No. 60/644,346, filed on Jan. 14, 2005.

(51) Int. Cl. B29C 45/14

(52) U.S. Cl. 264/261

(57) ABSTRACT

A method for making an individual PPTC electrical circuit protection device includes steps of inserting two surface-treated conductive electrodes into a mold; injecting plastic-phase PPTC material into a space between the two electrodes; closing the mold and thereby applying pressure to the electrodes and PPTC material to form a completed device; and removing the completed device from the mold. Mold temperature is controlled in a range of between 80 and 125° C.

### CROSS-REFERENCE TO RELATED APPLICATIONS

This application is an application under 35 USC 111(a) and claims priority under 35 USC 119 from Provisional Application Ser. No. 60/644,346, filed Jan. 14, 2005 under 35 USC 111(b). The disclosure of that provisional application is incorporated herein by reference.

### BACKGROUND OF THE INVENTION

1. Field of the Invention

The present invention relates to manufacturing methods for making polymeric positive temperature coefficient (PPTC) of resistance electrical circuit protection devices, and to the devices made by these methods. More particularly, the present invention relates to insert injection-compression molding of PPTC devices

2. Introduction to the Invention

Positive temperature coefficient (PTC) of resistance electrical devices are well known. Particularly useful devices contain PTC elements composed of a PTC conductive polymer, i.e. a composition comprising an organic polymer and, dispersed or otherwise distributed therein, a particulate conductive filler, e.g. carbon black, or a metal or a conductive metal compound. Such devices are referred to herein as polymer PTC, or PPTC resistors or resistive devices. Other PTC materials are also known, e.g. doped ceramics, but are not as generally useful as PTC conductive polymer, in particular because they often have higher non-operating, quiescent resistivities.

As used herein, the term “PTC” is used to mean a composition of matter which has an R₁₄ value of at least 2.5 and/or an R₁₀₀ value of at least 10, and it is preferred that the composition should have an R₃₀ value of at least 6, where R₁₄ is the ratio of the resistivities at the end and the beginning of a 14° C. range, R₁₀₀ is the ratio of the resistivities at the end and the beginning of a 100° C. range, and R₃₀ is the ratio of the resistivities at the end and the beginning of a 30° C. range. Generally the compositions used in devices of the present invention show increases in resistivity that are much greater than those minimum values.

The sharp increase in resistance of PPTC resistive devices is attributable to a phase change in the polymeric material. In its cool state, the material is mostly crystalline, and the conductive particles are forced into amorphous regions between the crystallites. If the percentage of conductive particles is sufficiently high, a level called the percolation level, the conductive particles touch, or nearly touch, forming a three-dimensional very low resistance conductive network. When the device becomes heated to the melting point of the polymer material, the crosslinked crystallites melt and become amorphous, disrupting the network of conductive paths. As the network is disrupted, the resistance of the device increases dramatically. Once current is removed from the device and the polymer recrystallizes, the very low resistance conductive network is reestablished, thereby providing an automatic reset of the PPTC resistive device.

Suitable conductive polymer compositions and elements, and methods for producing the same, are disclosed, for example, in U.S. Pat. Nos. 4,237,441 (van Konynenburg et al.), 4,545,926 (Fouts et al.), 4,724,417 (Au et al.), 4,774,024 (Deep et al.), 4,935,156 (van Konynenburg et al.), 5,049,850 (Evans et al.), 5,250,228 (Baigrie et al.), 5,378,407 (Chandler et al.), 5,451,919 (Chu et al.), 5,701,285 (Chandler et al.), 5,747,147 (Wartenberg et al.) and 6,130,597 (Toth et al.), the disclosures of which are incorporated herein by reference.

PPTC resistive devices can be used in a number of different ways, and are particularly useful in circuit protection applications, in which they function as remotely resettable devices to help protect electrical components from excessive currents and/or temperatures. Components which can be protected in this way include motors, batteries, battery chargers, loudspeakers, wiring harnesses in automobiles, telecommunications equipment and circuits, and other electrical and electronic components, circuits and devices. The use of PPTC resistive elements, components and devices in this way has grown rapidly over recent years, and continues to increase.

Traditional injection molding has been proposed in the prior art for the formation of PPTC electrical devices. However, test data collected for devices made by injection molding has demonstrated that such devices have lower performance ratings compared to PPTC resistive devices made by extrusion-lamination procedures using the same material. This reduction in performance has been thought to be caused by melt flow pattern and residual stresses in the polymer matrix resulting from high pressure injection of the polymer-conductive particle mixture through a narrow opening, or mold gate, and rapid flow-cool conditions inherent with injection molding processes. The internal stresses have introduced a higher variability in the resistance of the resultant devices and have reduced high-voltage cycling performance. Accordingly, while the prior art, such as commonly assigned U.S. Pat. No. 5,122,775 to Fang et al., for “Conduction Device for Resistive Elements”, suggests at column 3, lines 14-19 that “the invention is also useful in processes in which each device is manufactured separately, e.g. by injection molding, in order to simplify the steps of the process and/or complexity of the mold or other equipment”, commercial practice and success have been focused essentially upon the extrusion-lamination formation method.

With reference to FIG. 1, the extrusion-lamination production method steps of the prior art are illustrated and summarized. PPTC electrical devices are typically produced in commercial quantities by in-line extrusion of plastic-phase polymer resistive material and cooling to solidification to form a planar sheet at a process step 20. The extruded sheet is then divided into smaller separate sheets. The next step is lamination, attachment, or affixation of thin, typically 0.05 mm (0.002 inch) thick surface-treated nickel or copper foil conductor sheets to opposite major surfaces of each PPTC resistor sheet by application of temperature and pressure in a press, to produce a laminate structure, as diagrammed at process step 22. Alternatively, the electrode foils may be spooled from coils and laminated by application of pressure and temperature via rollers onto the extruded sheet of polymer resistive material in a continuous flow process. The laminate sheets may then be punched, sheared, sawn or otherwise divided into small parts or chips as illustrated at a process step 24. The individual chips then typically undergo a subsequent process step 26 at which stamped terminals are provided, or wire leads are attached by soldering or welding, to facilitate mounting and connection of the resultant PPTC resistive devices to printed circuit (PC) boards. In some designs the chip is not attached to wire or strap leads but to thick brass terminals (often between 0.25 mm (0.010 inch) and 0.50 mm (0.020 inch) thick). These brass terminals add rigidity and robustness to the design and give an added thermal mass to the device which is important for certain specific applications. Finally, the resultant PPTC electrical devices are subjected at a process step 28 to exposure of highly energetic radiation, such as electron or cobalt ion beams, in order to crosslink the polymeric matrix and achieve desired electrical characteristics in each device.

While the conventional manufacturing method outlined in FIG. 1 has worked well for many years, it has several drawbacks. First, the conventional method requires a number of separate steps, each of which adds cost to the final device. Second, there are certain applications and end uses for PPTC resistor circuit protection devices, such as those providing circuit protection for relatively high voltage circuits, e.g. greater than 60 volts, that have not been fully satisfied with devices made by the conventional extrusion-lamination method. Third, after plaque has been punched into chips, a shell of scrap foil and polymer remains. A related problem associated with continuous flow laminar processes is that an initial portion of the run results in scrap before the process reaches design equilibrium. Fourth, and perhaps of most significance, the extrusion-lamination method cannot be employed to fabricate thick electrode devices directly by eliminating the metal foil conductor layers.

Injection molding of useful articles is known in the art. Plastic pellets are collected in a hopper and fed into a reciprocating screw. The screw heats the pellets to plastic phase and to homogenize the plastic pellet material before it is injected into a mold cavity formed by two mold parts through a nozzle by forward reciprocation of the screw. During injection molding, injection pressures are applied directly to the plasticized material and can reach 69 to 138 MPa (10,000 to 20,000 pounds per square inch), or more. After the molded article cools, one part of the mold is moved back and the article is ejected by ejector pins or a panel. Coolant may be circulated through temperature control channels of the mold to provide active cooling following injection molding, causing the plastic material to solidify rapidly and decrease overall cycle time. One drawback of injection molding is that the viscosity of the plastic material locks stress into the molded article, especially when cooling time is shortened, most often manifested as physical deformation or warpage of the articles following ejection from the mold. One prior solution has been to include ribs or other supporting features into a thin-walled molded plastic article to provide rigidity to counteract warpage.

Injection-compression molding is a two phase operation in which plastic phase material is injected into a partially open mold in a first phase. In a second phase the mold is closed, compressing the molten plastic material under very high pressure into the desired shape defined by the mold cavity. The workpiece cools and is ejected by pins or a plate. Injection-compression molding is often used in cases where thin walled plastic parts must be made without ribs or supporting features and where maintaining close dimensional tolerances is very important, such as in the manufacture of compact discs and optical lenses.

Insert molding is a manufacturing process that can be derived from either injection molding or injection-compression molding. Insert molding is used when an application requires that a composite plastic-metal article be created with a metallic element or insert embedded within the molded plastic body. A common example is a plastic article having a threaded metal shaft. The metal insert is first placed into the mold and the plastic material is then injected and molded under pressure to form the composite article.

A hitherto unsolved need has remained for an improved method for making PPTC resistive devices with fewer process steps and at lower cost than the conventional method. In addition a hitherto unsolved need has remained for PPTC resistive devices capable of providing reliable circuit protection to relatively high voltage circuits and for an improved method for making such devices.

### BRIEF SUMMARY OF THE INVENTION

A general object of the present invention is to provide a method for manufacturing PPTC resistive devices with terminal electrode panels or foils attached in a single manufacturing step, in a manner overcoming limitations and drawbacks of the prior art.

Another object of the present invention is to provide a manufacturing method for PPTC resistive devices that achieves low residual stress in each molded device.

Another object of the present invention is to provide a manufacturing method for PPTC resistive devices that provides continuous product flow enabling reel-to-reel capability.

Another object of the present invention is to provide a manufacturing method for PPTC resistive devices having thick metal electrodes that eliminates steps of foil lamination and electrode soldering required by the prior art extrusion-lamination methods exemplified in FIG. 1.

Another object of the present invention is to provide an insert injection-compression molding process for manufacturing PPTC resistive devices that includes ways for controlling the temperature of the mold and the molded panel during the manufacturing process.

Another object of the present invention is to provide a method for modifying facing major surfaces of metal electrode panels to achieve good adhesion to PPTC material during insert injection-compression molding of PPTC resistive panels.

In accordance with principles and aspects of the present invention, a method for making PPTC resistive panels includes the steps of:

(a) inserting metal electrodes having oppositely facing major surfaces modified for good adhesion into opposite sides of an open mold cavity;

(b) injecting a controlled amount of PPTC material in plastic phase into the mold cavity in a partially closed position;

(c) completely closing the mold cavity and compressing the PPTC material to occupy a predetermined thickness between the two metal electrodes; and,

(d) opening the mold and ejecting the PPTC resistive panel having the electrodes integrally attached thereto. In this aspect of the invention, the metal electrodes may be metal plates having a thickness at least 0.127 mm (0.005 inch), or may be metal foils having a thickness not greater than 0.5 mm (0.020 inch), for example. The mold apparatus is most preferably heated in a range of between 80° C. and 125° C. during the insert injection-compression molding cycle.

In the example of molding PPTC-metal plate devices, the oppositely facing major surface of the metal electrode plates are processed by steps of:

(e) chemically etching the major surface to provide a roughened surface; and

(f) depositing metal, e.g. by electroplating, to grow dendrite-like nodules on the roughened surface.

As one related aspect, the method may include a step of irradiating (crosslinking) the PPTC resistive panel and includes a further step of dividing the PPTC resistive panel into individual PPTC electrical devices.

These and other objects, advantages, aspects and features of the present invention will be more fully understood and appreciated upon consideration of the detailed description of preferred embodiments presented in conjunction with the following drawings.

### BRIEF DESCRIPTION OF THE DRAWINGS

The invention is illustrated by the drawings in which FIG. 1 is a diagrammatic illustration of a multi-step, multi-station, extrusion-lamination method for making PPTC resistor devices in accordance with the prior art.

FIG. 2A is a diagrammatic view in elevation and section of an insert injection-compression mold in opened position for making PPTC resistor devices in accordance with the present invention, showing insertion of surface-treated electrode panels into the mold cavity.

FIG. 2B shows the injection of plastic-phase PPTC material into the FIG. 2A mold cavity.

FIG. 2C shows the closure of the FIG. 2A mold cavity and the insert injection-compression molded PPTC resistive panel produced by the method of the present invention.

FIG. 3A is an injection-side view of the FIG. 2C molded PPTC resistive panel.

FIG. 3B is an enlarged sectional view of the FIG. 2C molded PPTC resistive panel taken along line 3B-3B in FIG. 3A.

FIG. 4 is a diagrammatic view in section and side elevation of the first mold half of FIGS. 2A-C showing inclusion of a heat-transfer plate against the molded PPTC panel 10 in accordance with aspects of the present invention.

FIG. 5A is an enlarged diagrammatic view in section and elevation of a terminal panel segment undergoing a preliminary surface etch process as part of a preferred terminal electrode surface treatment in accordance with aspects of the present invention.

FIG. 5B is an enlarged diagrammatic view in section and elevation of the FIG. 5A terminal panel segment on which surface nodules of metal have been formed to complete the preferred terminal electrode surface treatment.

FIG. 6A is enlarged side view of a brass terminal PPTC device without foils that has been insert injection-compression molded in accordance with principles of the present invention.

FIG. 6B is an isometric projection of the FIG. 6A device.

FIG. 6C is a greatly enlarged photomicrograph of a small portion of a pre-etched nodularized surface of one of the two brass terminal electrodes forming the FIG. 6A-B device.

FIG. 7 is a graph of data plotting resistance of 27 individual PPTC devices of the type shown in FIGS. 6A and 6B taken across a molded PPTC panel and after crosslinking by exposure to beam radiation.

FIG. 8 is a graph plotting resistance of FIG. 6A devices over two temperature cycles showing PTC anomaly (i.e. autotherm height) characteristics.

FIG. 9 is a graph plotting device resistance over 1000 cycles during cycle life testing at 16 volts, 40 amperes of FIG. 6A devices.

FIG. 10 is a graph plotting resistance during cycle life testing at 16 volts, 5 amperes, of FIG. 6A devices over a cycle interval of seven days.

FIG. 11A is a plan view of the injection side (Side A) of an insert injection-compression molded laminar PPTC panel using 0.1 mm (0.004 inch) thick foils in accordance with the present invention.

FIG. 11B is a plan view of the opposite side (Side B) to Side A of the insert injection-compression molded laminar PPTC panel of FIG. 11A.

FIG. 12 is a graph of integer-normalized data showing peel strengths from Side B numbered strips (FIG. 11B) of four molded laminar PPTC panels at four molding temperatures Tₘ.

### DETAILED DESCRIPTION OF THE INVENTION

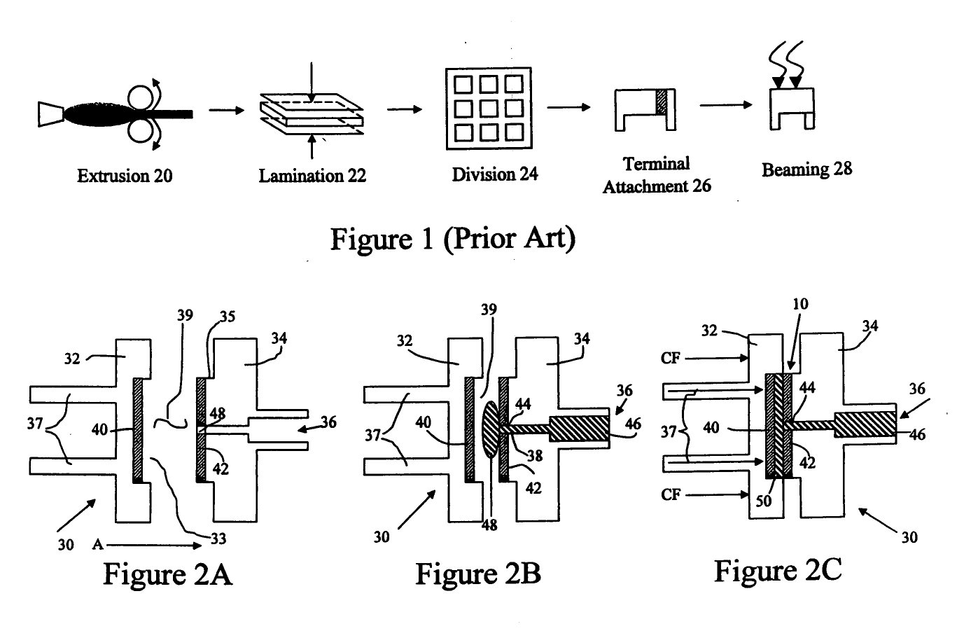

With reference to FIGS. 2A, 2B and 2C, a conventional insert injection-compression mold apparatus 30 includes a first mold half 32 having a precision recess 33, and a second mold half 34 having a precision projection or plateau 35 which is sized to mate with the recess 33 along a closure axis A. The mold apparatus 30 includes conventional guiding means, such as shafts or rails, or the like (not shown) for guiding the first mold half 32 and the second mold half between open and closed positions. FIG. 2A illustrates the mold apparatus 30 in an open position, defining a work space 39. The mold apparatus 30 includes internal means for heating (and cooling) the molding major surfaces provided by the recess 33 and the plateau 35. The first mold half 32 includes an ejector pin mechanism 37. The second mold half 34 includes a conduit or passage 36 leading from a supply of heated, plastic-phase PPTC material 46. The passage 36 communicates with a narrowed injection barrel and nozzle structure 38 through which the plastic-phase PPTC material 46 is injected with the mold partially open, as shown in FIG. 2B.

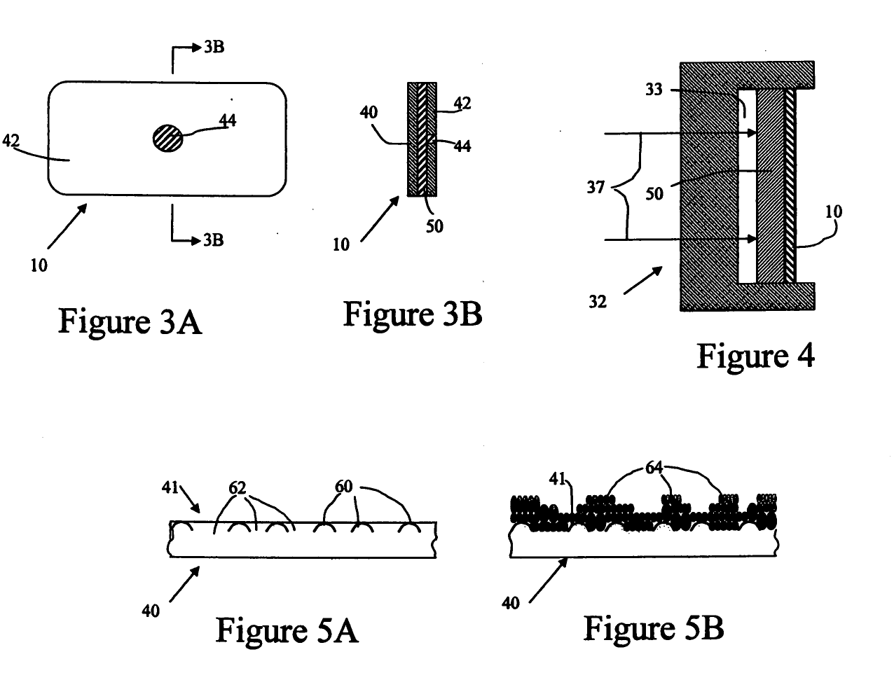

Returning to the description of FIG. 2A showing the mold in a fully open cavity position, a first electrode foil or plate 40 is inserted into, and retained by the structure defining the mold recess 32 by any suitable retaining means, such as vacuum suction. A second electrode foil or plate 42 defining a central opening 44 is positioned and retained upon the plateau structure 35 by suitable means such as vacuum, or guide pins, for example, so as to be registered and held in alignment with the PPTC material nozzle 38 and with the panel 40 when the mold apparatus 30 is moved to a closed, compression position, shown in FIG. 3B. The outer major confronting surfaces of the foils or panels 40 and 42 are most preferably provided with a surface treatment, described hereinafter in connection with FIGS. 5A and 5B, to promote effective adhesion of PPTC resistive material 46 to each foil or panel 40, 42.

FIG. 2B illustrates injection of a metered volume of plastic-phase PPTC material, denoted by reference numeral 48, through the injection barrel and nozzle assembly 38, the central opening 44 of plateau-mounted plate 42, into a workspace 39 defined by the mold apparatus 30 in a partially open position. Once the proper quantity of plastic phase PPTC material 48 is in place, the mold apparatus 30 is closed and a compression force, denoted by arrows labeled CF in FIG. 3C, is applied to the laminar structure 10 including electrode panels 40 and 42, and PPTC material 50. Desired compressive forces CF are in a range of 41.4 to 69.0 MPa (6,000 to 10,000 pounds per square inch), for example.

Mold temperature control is important to successful manufacturing of the laminar panels 10 in accordance with the present invention. In one example a mold apparatus employed fluid heating in which the heating fluid was maintained at 120° C., while the mold surface temperatures never exceeded 75° C., plus or minus 5° C. In this example, the PPTC material layer 50 cools very rapidly before and during the compression step and dominated other process variables. Cooling time following the compression step was approximately 40 seconds. Also, it was noted that the use of this fluid heating of the mold resulted in excessively viscous plastic-phase PPTC material, making it very difficult to make thin layered PPTC devices.

When an electrically heated mold was employed it became possible to heat the molding surfaces higher than 75° C., and molding and compression at 127° C. was carried out. However, cooling time in ambient air following the compression step required about ten minutes, and it was found that the molded panel 10 had to be cooled to a temperature below 115° C. before being ejected from the mold 30 by operation of the ejector pin mechanism 37. Otherwise, the panel 10 can become deformed by the ejector pins of mechanism 37. Employing a mold apparatus having active heating and cooling elements reduces the cooling time of the panel 10.

After the PPTC panel 10 is removed from the mold apparatus 30 and cooled, it may be further processed by crosslinking (e.g. by means of an electron beam) either before or after being sheared, stamped, cut, sawn or otherwise divided into individual devices.

FIGS. 3A and 3B illustrate the insert injection-compression molded PPTC panel 10 made in accordance with the method of the present invention. The panel 10 is dimensioned and shaped to take advantage of the molding capability of the particular molding apparatus 30, which in this example is approximately 152 mm (6 inch) long by 76 mm (3 inch) wide. Larger mold cavities having multiple injection barrels and nozzles are clearly within contemplation of the present invention.

In addition to active cooling, or alternatively, as shown in FIG. 4, a heat conduction plate 50, formed e.g. of steel or other suitable material, may be used during the molding process to maintain molded shape of and conduct heat out of the molded panel 10 following compression and ejection. Use of the plate 50 enables the molded PPTC panel 10 to be removed from the mold apparatus 30 without warping. In addition, cooling time of the panel 10 is significantly decreased without any reduction of adhesion between the panels 40 and 42 and the PPTC layer 50.

In order to achieve satisfactory bonding between the metal electrode panels 40, 42 and the PPTC layer 50, a suitable surface treatment is provided for the metal major surfaces confronting the PPTC layer 50. While a wide variety of surface treatments are known in the art such as abrasion and coining, a presently preferred chemical etch treatment is illustrated in FIG. 5A and a subsequent plating treatment is shown in FIG. 5B.

Turning to 5A, a first step is to create a roughened surface 41 on the metal electrode plate, e.g. plate 40, it being understood that the same treatment is applied to a surface of electrode plate 42. The plate 40, 42 is typically of brass or copper or alloys and preferably has a thickness of 0.51 mm (0.02 inch). While surface roughening can be carried out by abrasion with fine-grit sandpaper having grit size in a range of 240 to 600 particles per square inch, or by use of carbide dust applied to the surface at pressure via a nozzle (sand blasting), most preferably surface roughening is carried out with a chemical etch employing ferric chloride and hydrochloric acid (FeCl₃+HCl). The resulting roughened surface has roughened plateaus 60 and recesses 62 as diagrammed in FIG. 5A.

Turning now to FIG. 5B, after the plate surface has been roughened, conventional nodular plating techniques, e.g. electroplating, are employed to create dendrite-like metallic nodules 64, for example of from 3 to 15 microns high, onto the surface treated metallic surface 41. For example if nickel plating is used, a thin nickel underplate having a thickness of less than one micron is applied to the surface by electroplating at low current density. A nodular treatment is then applied using a low concentration nickel bath operated at high current density. Finally, the nodules 64 are thickened by plating again at low current density. By following this preferred sequence larger nodules can be grown. Larger nodules have been found to provide greater bond strength between the metal panel 40 and the PPTC layer 50.

Molded PPTC-Metal Plate Circuit Protection Device Example

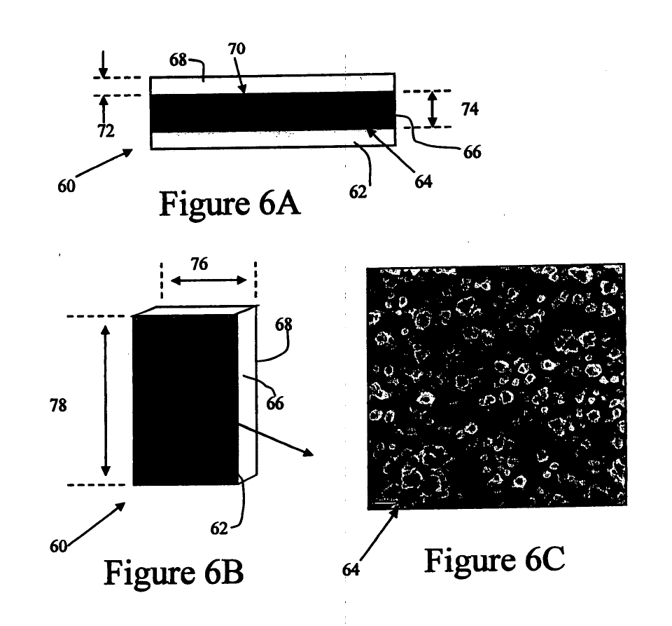

FIG. 6A shows an insert injection-compression molded PPTC device 60 including a first electrode plate 62 having an interior major surface 64 defining dendrite-like nodules (shown in the greatly enlarged photomicrograph of FIG. 6C), a PPTC material layer 66 which, in this example is a polyvinylidene fluoride polymer matrix in which 29.4 percent by weight carbon-black is fully dispersed. A second electrode plate 68 includes an interior major surface 70 also defining the dendrite-like nodules of FIG. 6C. The brass electrode plates 62 and 68 have a thickness dimension 72 of 0.51 mm (0.02 inch), and the PPTC layer 66 has a dimension of 1 mm (0.04 inch), for example. As shown in FIG. 6B, the PPTC device 60 has a length dimension 78 of 11 mm (0.43 inch), and a width dimension of 8.1 mm (0.32 inch), for example. Greatest shear strength resulted when the insert injection-compression mold apparatus 30 heated the mold cavity and PPTC material in a range of between 115° C. and 128° C.

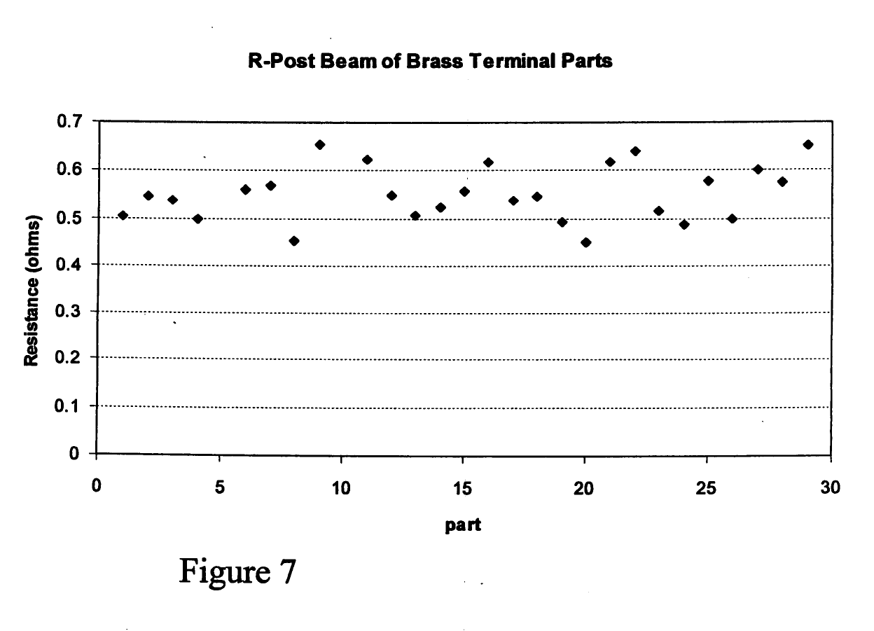

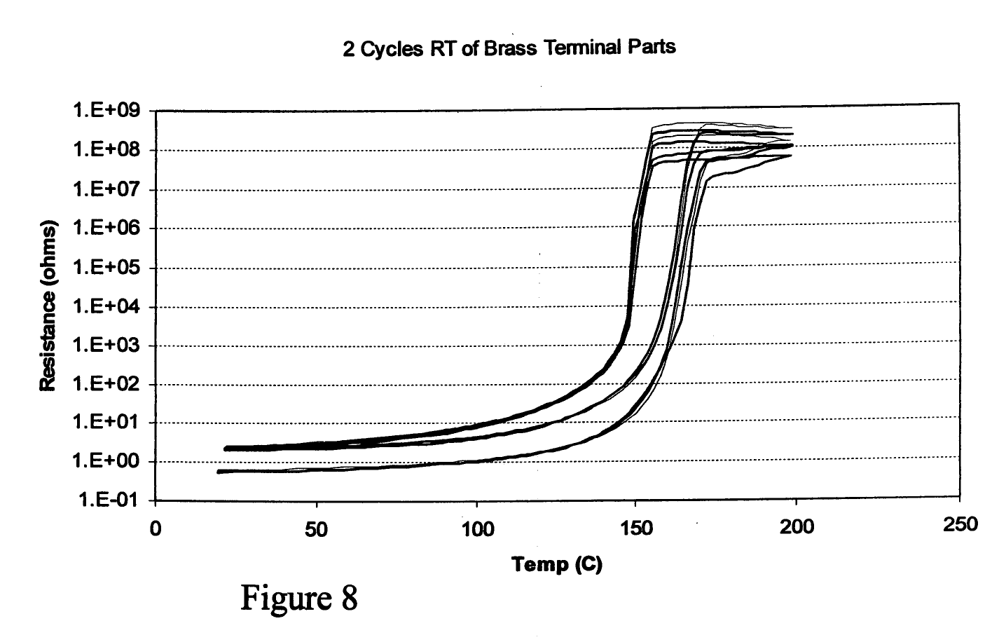

FIG. 7 shows resistance values of twenty seven devices punched or divided along a length dimension of a FIG. 3A molded PPTC laminar panel 10. The data shown in FIG. 7 reflects a minimum resistance of 0.451 ohm, a mean resistance of 0.552 ohm, a maximum resistance of 0.653 ohm and a standard deviation of 0.057. FIG. 8 shows resistance values of three molded brass electrode PPTC devices 60 taken over two temperature cycles between 20° C. and 200° C. (In this test a resistance increase, known as the PTC anomaly or “autotherm height” (ATH) is measured. ATH is the number of orders of magnitude or decades between chip resistance at 20° C. and chip resistance at 130° C.). FIG. 8 shows about eight decades of ATH values for the parts, the highest ATH being 8.19, the lowest being 7.642 and the intermediate value being 8.062. These ATH values are several orders of magnitude higher than ATH values measured for conventionally extruded PPTC foil chip devices having similar initial resistance values.

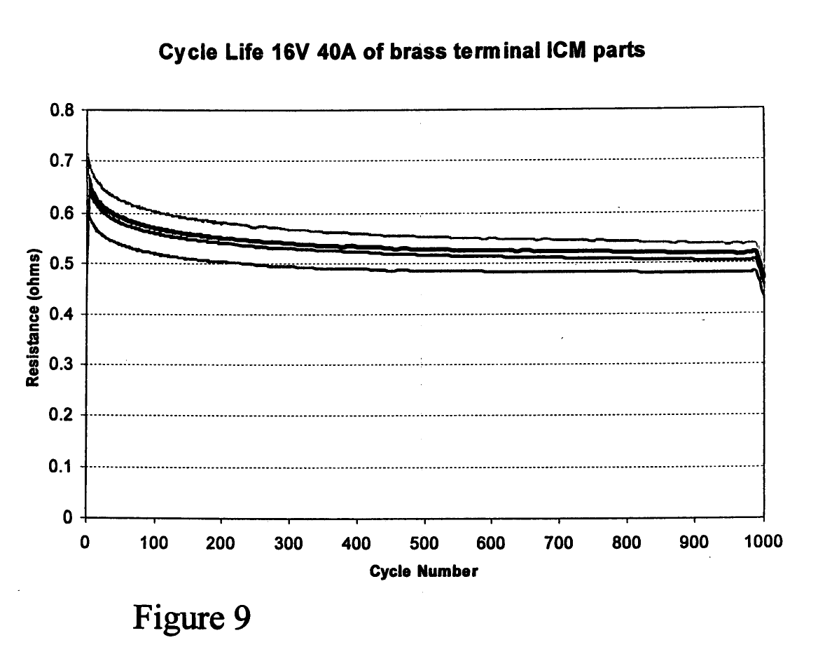

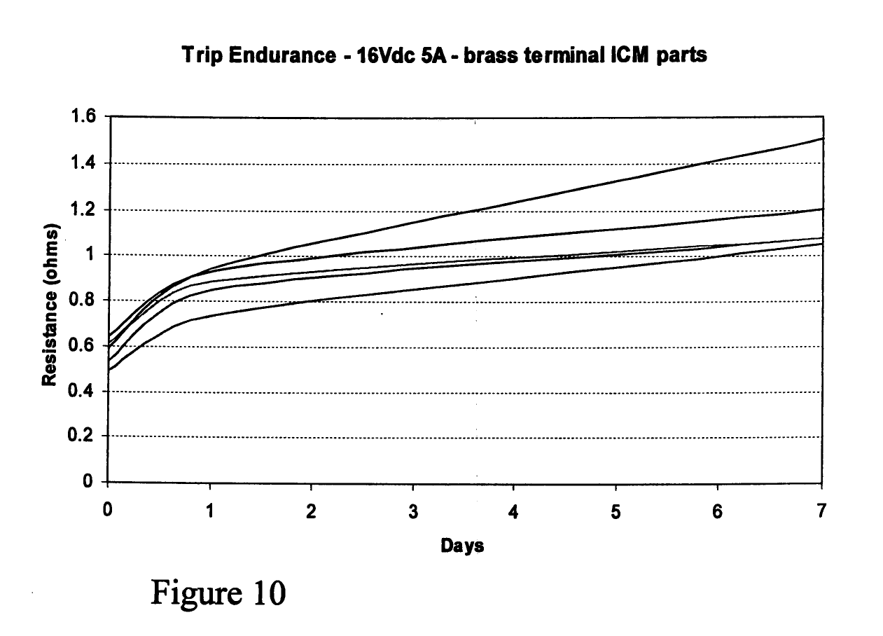

FIG. 9 graphs resistance of devices 60 over standard cycle life testing cyclically carried out at 16 volts, 40 amperes, five second intervals, spaced by cooling intervals, over 1000 cycles, showing consistent decay patterns for the devices. FIG. 10 graphs resistance of devices 60 over standard cycle life testing cyclically carried out at 16 volts, 5 amperes, five second intervals, separated by cooling intervals, over a seven day period, showing a slight increase in untripped resistance over the test week.

PPTC-Metal Foils Devices Peel Test Example

As shown above, the present invention works very well in providing molded PPTC protection devices using brass plate electrodes. The invention also works well in making laminar molded PPTC devices having thin foils. One method for determining how well the PPTC material has become engaged with the surface treated electrical foils is by measuring peel strength. The peel strength test is used to indicate how well polymer flows during compression phase of the insert injection-compression molding cycle. If peel strength is poor, electrical arcing may occur between the terminals and the polymeric layer, causing sparks and possible device failure. In making test panels injection-compression molding apparatus defining a 152 mm×76 mm (6 inch by 3 inch) cavity was used. The mold apparatus included five ejector pins for ejecting the injection-compression molded PPTC panel after each molding operation. The mold was set up such that a polymeric material of high density polyethylene filled with carbon black could be injected into the cavity and compressed to a final thickness selectable within a range of 6.4 mm (0.25 inch) to 0.25 mm (0.010 inch), depending upon the metal insert foil/panel thicknesses and the amount of material initially injected into the mold. In this example, 0.1 mm (0.004 inch) nickel foils were inserted into the mold. The 0.1 mm (0.004 inch) nickel foil provides a more rigid terminal, and larger nodules for better adhesion than thinner foils, such as the 0.05 mm (0.002 inch) nickel foil typically used with conventional extrusion-lamination PPTC devices. Herein, the tests of molded PPTC foil devices relate to injection-compression molded (ICM) parts having 0.1 mm (0.004 inch) thickness nickel foils.

The insert foils had surfaces confronting the polymer material processed to form nodules of the type illustrated above in FIGS. 5A and 5B. The mold of apparatus 30 could be controllably heated and maintained at a selected temperature in a range between 20° C. and 300° C. by internal electrical heating elements. It was determined that when the mold temperature was 90° C., only about 50 percent of total plaque foil was being penetrated by the polymer. However, a mold temperature of 102° C. and above heated the polymer sufficiently to retain enough heat during the compression phase to penetrate the entire nodular foil surfaces.

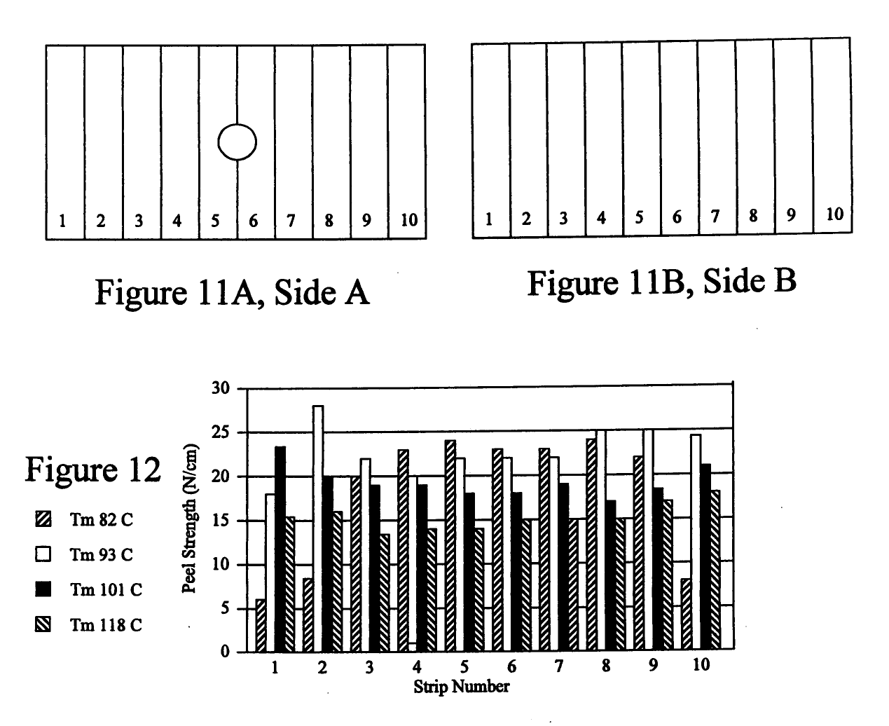

Four sample PPTC-electrode foil laminar panels were molded, permitted to cool for 20 seconds following ejection and tested for peel strength. FIG. 11A shows injection side A and FIG. 11B shows opposite side B of each of the four sample laminar PPTC panel being divided into ten numbered strips, with strips 5 and 6 of side A not being used in a standard foil peel test measured in force applied per linear distance of peel. FIG. 12 graphs side B peel strength in Newtons per centimeter for the sample laminar PPTC panels molded respectively at mold temperatures of 82° C., 93° C., 101° C. and 118° C.

When the mold is heated at 82° C., the values of peel strength are high for many of the middle strips and low at the edge strips. There is a difference of 18 N/cm between the highest and lowest values of peel strength. The 93° C. sample panel has much higher values for the edge strips than the 82° C. sample, and the greatest difference in peel strength is 10 N/cm. The 101° C. sample panel is more consistent across the panel, but has slightly higher values of peel at the edge strips than for the middle strips. This sample panel's peel strength varies by 5.5 N/cm. The last sample panel, made at 118° C. has the most consistent values of peel strength, varying no more than 4 N/cm in its peel strength values. Also, the sample made at 118° C. shows considerable uniformity and higher correlation for A side peel strengths with the B side peel strengths graphed in FIG. 12. The data collected in testing shows that as mold temperature increases, peel strength across the molded laminar PPTC foil panel becomes more consistent. At a mold temperature of 118° C., there is almost complete consistency in peel strength values across the sample panel. However, while uniformity across the panel has increased, the peel strength seems to decrease across the test panel with higher mold temperatures. Thus, the test panel made at 101° C. may be more favorable from an overall robustness point of view. These values compare very favorably to conventional extrusion-lamination plaques which rarely have foil peel strengths higher than 9 N/cm.

Metal Foil PPTC Device Electrical Testing Example

It is very important for PPTC devices to have uniform resistivity when they are employed to protect electrical circuits. In this example, two laminar PPTC-foil panels using 0.1 mm (0.004 inch) nickel foil electrode inserts were made as set forth in the peel strength example above. One panel was molded at a temperature of 115° C., and the other panel was molded at a temperature of 125° C. Small chips were punched out of the panels after molding and before beam irradiation. The chips were 8 mm by 13.5 mm (0.32 inch by 0.53 inch) and had a polymer thickness of 2 mm (0.08 inch). Test chips were punched along the length (i.e. the longest) dimension of the panel from edge to edge, in the same manner as peel strength strips were punched. Twelve chips were punched at equal intervals along the panel. Test data showed that initial resistance in ohms varied from a high of 0.36 ohm at an edge chip to a low of 0.27 ohm at chip 9 in the 115° C. family. Much less variation in resistance was seen in the chip family from the panel made at 125° C. In those chips resistance ranged from 0.31 ohm to 0.27 ohm. Measurements established that the 125° C. panel showed a more uniform cross sectional thickness and resistances. The 115° C. panel showed ten percent thickness increases at the edges and thirty percent variations in resistances, edge to edge.

Next, resistance jump was measured for the chips punched across the molded laminar PPTC-foil panel. For this test the initial resistance measurements are compared to resistance measurements after beaming and heat treatments. The sample chips were irradiated to crosslink the polymer material and were subjected to heat during terminal soldering and annealing steps. The average resistance of the molded chips directly after punching from the molded laminar PPTC-foil panel was 0.3 ohm. After the crosslinking and heat treatment steps, the average resistance of the chips had increased to 1.5 ohm. Before crosslinking and heat treatment, the resistance of individual chips tended to vary as much as 20 percent, whereas after crosslinking and heat treatment chip resistance varied by no more than nine percent.

Next, the molded chips were tested for Resistance v. Temperature (RT) characteristics and were compared to extrusion chips made by conventional methods. RT tests are normally performed in lots of 20 devices. In this test the extruded chips were made of 38 percent carbon-black in HDPE by weight, whereas the molded laminar chips were 37 percent carbon-black in HDPE by weight. The initial resistance of the molded chips was lower than the extruded chips. The molded chips had an ATH of 4.39 decades while the extruded chips had an ATH of 4.47. When the initial resistances are normalized, the molding process produced similar ATH as manifested by the conventional extruded chips. There is some evidence that the insert injection-compression molding process results in molded PPTC-foil devices which use the carbon-black more efficiently than devices made by conventional extrusion-lamination methods, based on the lower initial resistance of the molded chips containing PPTC with a lesser concentration of carbon-black.

The next test compared resistance versus temperature of molded chips with resistance versus temperature of conventional extruded chips. For this test, the carbon-black loading of the molded laminar PPTC panel was reduced to 35.8 percent by weight, so that the initial resistance of molded devices was 2.46 ohms, while the conventional extruded chips had an initial resistance of 2.3 ohms. Normalized resistance-temperature data for the molded chips and the extruded chips shows that the molded chips obtain an ATH of 5.4 decades which is nearly one order of magnitude greater ATH obtained from the conventional extruded chips (ATH equals 4.4 decades). The ATH for the molded chips basically tracks the initial resistance of each chip based on position across the molded PPTC laminar panel.

High voltage rated PPTC devices are subjected to electrical stress cycle testing. The polymer composition and geometry of the device is designed to withstand large power surges. In cycle life tests, these devices are typically tested at one of the following: 250 volts at three amps for 100 cycles; 600 volts at 2.2 amps for 100 cycles; 600 volts at seven amps for ten cycles; or, 600 volts at 60 amps for three cycles. Each test holds the device at the stated power level for five seconds and then provides a 120 second cool off interval before the next power cycle. The chip devices molded in accordance with the present invention (35.8 percent carbon-black in HDPE) passed the 250 volt, three amp test at a 100 percent pass rate.

The resistance behavior during the 600 volt at 2.2 amp cycle life testing is tabulated in summary form in the table, below, which compares results for conventional 38 percent carbon-black extruded parts with 35.8 percent carbon-black molded parts. Before each power cycle, the testing machine measures the resistance of the devices undergoing testing. The resistance jumps significantly for the first two cycles, and then decays slowly during the additional 98 cycles that follow. The resistance is recorded for all 100 cycles, but the initial cycle, the second cycle, the tenth cycle and the 100^{th} cycle resistances are most frequently used for comparison, as shown in the table below. The resistance at any particular cycle, R_{f}, divided by the initial resistance is known as the trip jump, TJ. During the testing reported in the table, below, usually only one molded chip device of 25 undergoing testing would fail.

TABLE

| | Extruded Devices | | Molded Devices | |
|---|---|---|---|---|
| Cycle | Resistance (ohm) | Trip Jump | Resistance (ohm) | Trip Jump |
| 0 | 2.3 | | 2.5 | |
| 2 | 4.42 | 1.88 | 4.76 | 1.85 |
| 10 | 4.17 | 1.77 | 4.61 | 1.79 |
| 100 | 3.73 | 1.59 | 4.36 | 1.69 |

The 600 volt at 7 amps over ten cycles test proved more challenging for the molded devices. A typical performance specification for high voltage PPTC devices is that each device withstand one cycle at 600 volts, 7 amps. In tests half of the molded devices survived all ten cycles of this test. These devices had a normal resistance jump after the first cycle, and then had a constant or slightly decreasing resistance throughout the remaining nine cycles. For the molded chips that survived this test, they seem to have almost identical trip jump behavior as is summarized in the table above for the 600 volt, 2.2 amp test.

The 600 volt at 60 amp two cycles test is by far the most aggressive and harsh of the standardized tests. Fifty of the molded 35.8% carbon-black chip devices were tested at the 600 volt, 60 amp settings. Only seven failed during the first cycle. The increase in chip resistance following the initial cycle averaged at about six ohms, with some devices less and some at as much as 12 ohms. Unlike previous testing, substantial polymer oxidation within each chip may have occurred in this first cycle. The trip jumps for the 60 amp test turned to be much more sporadic than those reported above in the table, suggesting that the first cycle of the lower amperage tests does not damage the polymer, while the 60 amp test oxidizes some of the polymer structure as early as the first cycle.

Having thus described preferred embodiments of the invention, it will now be appreciated that the objects of the invention have been fully achieved, and it will be understood by those skilled in the art that many changes in construction and widely differing embodiments and applications of the invention will suggest themselves without departing from the spirit and scope of the invention. Therefore, the disclosures and descriptions herein are purely illustrative and are not intended to be in any sense limiting.

What is claimed is:

1. A method for making an individual PPTC electrical circuit protection device comprising steps of:
(a) inserting two surface-treated conductive electrodes into a mold;
(b) injecting plastic-phase PPTC material into a space between the two electrodes;
(c) closing the mold and thereby applying pressure to the electrodes and PPTC material to form a completed device; and
(d) removing the completed device from the mold.

2. The method set forth in claim 1 comprising the step of heating the mold to a temperature in a range between 80° C. and 125° C. before the step of closing the mold.

3. The method set forth in claim 2 comprising the step of cooling the mold and the completed device prior to the step of removing the completed device from the mold.

4. The method set forth in claim 1 wherein the two surface treated conductive electrodes comprise metal plates having a thickness at least 0.127 mm (0.005 inch).

5. The method set forth in claim 1 wherein the two surface treated conductive electrodes comprise metal foils having a thickness not greater than 0.5 mm (0.020 inch).

6. A method for making a PPTC resistive device without using metal foils including steps of:
(a) inserting metal electrode plates having predetermined thicknesses at least equal to 0.127 mm (0.005 inch) and having oppositely facing major surfaces modified for good adhesion into opposite sides of a mold cavity defined by a mold;
(b) injecting a controlled amount of PPTC material in plastic phase into the mold cavity;
(c) closing the mold cavity and compressing the PPTC material to occupy a predetermined thickness between the two metal electrodes and to engage the oppositely facing major surfaces of the metal electrode plates; and
(d) opening the mold and thereupon ejecting the PPTC resistive device having the electrodes integrally attached thereto.

7. The method set forth in claim 6 wherein the oppositely facing major surface of the metal electrode plates are processed by steps of:
(e) chemically etching the major surface to provide a roughened surface; and
(f) depositing metal, e.g. by electroplating, to grow dendrite-like nodules on the roughened surface.

8. The method set forth in claim 6 comprising the step of heating the mold to a temperature in a range between 80° C. and 125° C. before the step of closing the mold.
